(19) United States
(12) Patent Application Publication
(10) Pub. No.: US 2019/0148735 A1
(43) Pub. Date: May 16, 2019

(54) POLYMER FIBER-CONTAINING MATS WITH ADDITIVES FOR IMPROVED PERFORMANCE OF LEAD ACID BATTERIES

(71) Applicant: JOHNS MANVILLE, Denver, CO (US)

(72) Inventors: Zhihua Guo, Centennial, CO (US); Gautam Sharma, Cleveland, TN (US)

(21) Appl. No.: 15/812,792

(22) Filed: Nov. 14, 2017

(51) Int. Cl. H01M 4/66; H01M 4/68; H01M 4/80; H01M 4/14; H01M 10/08; H01M 10/42; H01M 4/57; H01M 4/38; H01M 2/16

(52) U.S. Cl. CPC H01M 4/666; H01M 4/68; H01M 4/806; H01M 4/14; H01M 10/08; H01M 2300/0011; H01M 4/57; H01M 4/38; H01M 2/1633; H01M 2/162; H01M 10/4235

(57) ABSTRACT

A fiber-containing mats for a lead acid batteries are described. The mats contain a plurality of polymer fibers having at least one additive incorporated into at least a portion of the polymer fibers. The one or more additives suppress hydrogen evolution in the lead acid battery, and have a standard boiling point of 160° C. or more. Also described are lead acid batteries that include an electrode having an electrode active material held in a fiber-containing gauntlet made from a mat or fabric of polymer fibers having at least one additive for improving battery performance incorporated into the polymer fibers.

### BACKGROUND OF THE INVENTION

Lead acid batteries were first developed more than 150 years ago, and are recognized as the first rechargeable battery. Despite the development of many other battery technologies over the past 150 years, lead acid batteries still enjoy wide use today in a number of industries, especially for automobile starting, lighting and ignition (SLI) applications. While lead acid batteries have a relatively low energy-to-weight and energy-to-volume ratio compared to other types of battery systems, their ability to supply large amounts of current in short bursts give them one of the highest power-to-weight ratios of any battery system. The ability of lead-acid batteries to deliver high amounts of surge current to components like automobile starter motors have kept them an important part of the battery industry for many decades.

Lead acid batteries are also unusual among battery systems for using the same element, lead (having chemical symbol Pb), as the electro-active material in both the positive and negative electrodes of the battery. You can see an illustration of this in FIGS. 1A and 1B, which show diagrams of the chemical reactions taking place during the charging and discharging of a lead acid battery that uses an aqueous sulfuric acid solution as the electrolyte. The use of lead in both the positive and negative electrodes is possible because the lead compounds have different oxidation states in each electrode. The negative electrode includes lead metal, Pb(s), in the zero oxidation state (P⁰) that is oxidized to Pb²⁺ when the battery is discharged. In contrast, the positive electrode includes lead oxide, PbO₂(s), in the plus-four oxidation state (Pb⁴⁺) that is reduced to the same Pb²⁺ during battery discharge. The electrolyte in lead-acid batteries is aqueous sulfuric acid [H₂SO₄ (aq)], and the sulfate ions (SO₄²⁻) in the electrolyte counterbalance the Pb²⁺ ions formed during discharge at both the negative and positive electrodes to make solid lead sulfate (PbSO₄(s)). The conversion of Pb(s) to PbSO₄(s) at the negative electrode and the complementary conversion of PbO₂ to PbSO₄(s) at the positive electrode are reversed when a recharging current is supplied to the lead-acid battery, for example through the alternator of an automobile. The complete half reactions for the positive and negative electrodes can be written as follows:

Pb(s)+HSO₄⁻(aq) ↔ PbsO₄(s)+H⁺(aq)+2e⁻ (Neg Electrode)

PbO₂(s)+HSO₄⁻(aq)+3H⁺(aq)+2e⁻↔ PbSO₄(s)+2H₂O(I) (Pos Electrode)

Unfortunately, the electrode half reactions shown above are not the only reactions that can occur in a lead-acid battery: When a lead acid battery is charged too quickly, or continues to be charged at too high a voltage after reaching full charge, the electric current changes from (i) electrolyzing the lead sulfate back into lead (Pb(s)) and lead oxide (PbO₂(s)) to (ii) hydrolyzing the water in the electrolyte to hydrogen (H₂(g)) and oxygen (O₂(g)) gas. Not only does this reduce the amount of water present in the electrolyte, it also causes the buildup of an explosive gas mixture within the battery. If the gases are vented without replenishing the water, the battery could run dry resulting in the electrodes being permanently damaged or destroyed. Even worse, if the gases are not vented quickly enough to prevent a buildup of pressure, the pressurized hydrogen and oxygen gases could explode.

Another undesired reaction is the irreversible formation of large lead sulfate crystals on the electrodes in a process known as sulfation. These larger crystals of lead sulfate act as electrical insulators that attenuate and eventually stop electrical conduction though the battery's electrodes. Sulfation is most prevalent in batteries that are undercharged or slowly charged to give fine particles of lead sulfate a chance to act as seed crystals for the growth of larger lead sulfate crystals that cannot be eliminated by applying more charge. It is the most common cause of premature lead acid battery failure.

Lead acid battery developers have incorporated additives into the electrolyte solution that suppress the electrolysis of water from the electrolyte and the formation of large lead sulfate crystals on the electrodes. These additives have been shown to reduce maintenance costs and extend the lifetime of lead acid batteries. However, many of the additives themselves have lifetimes significantly shorter than the battery due in part to the highly reactive and corrosive environment of a concentrated sulfuric acid solution. Thus there is a need to develop new additives that are stable for extended periods of time in the difficult environment of a lead acid battery. There is also a need to develop new materials and methods that can introduce the additives to the electrolyte over an extended period of time. These and other challenges are addressed in the present application.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A is a diagram of the chemical reactions that take place in a lead-acid battery during electrical charging;

FIG. 1B is a diagram of the chemical reactions that take place in a lead-acid battery during electrical discharging;

FIG. 2 is a simplified schematic of an electrode plate and pasting mat according to embodiments of the invention;

FIGS. 3A-C are a simplified cross-sectional views of an electrode plate and one or more pasting mats according to embodiments of the invention;

FIG. 4 is a simplified schematic of a lead-acid battery with pasting mat gauntlets according to embodiments of the invention;

FIG. 5 is an exploded view of selected components of a lead-acid cell according to embodiments of the invention;

FIG. 6 is a cut-away view of a flood lead-acid battery according to embodiments of the invention;

FIG. 7 is a flowchart showing selected steps in a method of making a mat having polymer fibers according to embodiments of the invention;

FIG. 8 is a flowchart showing selected steps in an additional method of making a mat having polymer fibers according to embodiments of the invention;

FIG. 9 shows a scan plot of current versus voltage difference in an ECC test for glycol ester additive and blank samples;

FIG. 10 shows a scan plot of current versus voltage difference in an ECC test for vanillin additive and blank samples;

FIG. 11 shows a scan plot of current versus voltage difference in an antimony suppression test for glycol ester additive, Sb added, and blank samples; and

FIG. 12 shows a scan plot of current versus voltage difference in an antimony suppression test for vanillin additive, Sb added, and blank samples.

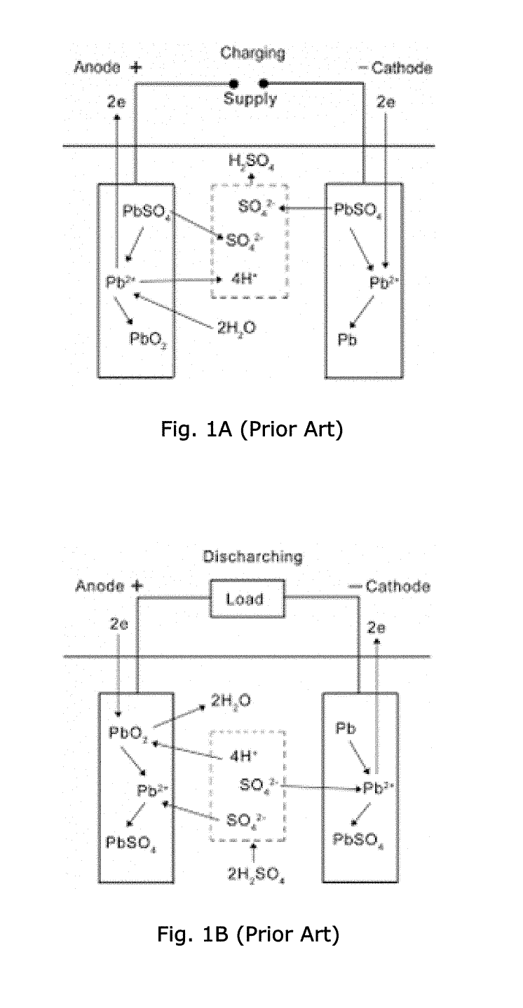

### BRIEF SUMMARY OF THE INVENTION

Fiber mats are described that incorporate one or more additives into the polymer fibers of the mat to extend the operational performance and lifetime of lead acid batteries. The additives are incorporated directly onto polymer fibers that make up the mat. They may also be incorporated into a binder that holds the fibers together when one is used. The incorporation of the additives into the polymer fibers of the mats permits the additives to be released over time into the battery's electrolyte. The mat acts as a replenishing source of the additives for the electrolyte, keeping them at a higher level than if all the additives were originally dissolved in the electrolyte.

Some additives have been identified as being especially well suited for incorporation in the polymer fibers of the mats: Benzyl benzoate is an aromatic ester that inhibits the crystallization of lead sulfate, and is therefore an effective sulfation inhibitor in lead acid batteries. In addition, benzyl benzoate can suppress the evolution of hydrogen and oxygen. Unfortunately, the ester bond in benzyl benzoate is prone to hydrolysis in the highly acidic environment of a sulfuric acid electrolyte solution. This makes benzyl benzoate a poor choice of additive for direct addition to a lead acid battery electrolyte because its concentration drops below a level needed to act as an effective sulfation inhibitor well before the expected expiration date of the battery. Incorporation of benzyl benzoate into the polymer fibers of the mat that makes contact with the electrolyte allows its replenishment in the electrolyte over a significantly longer duration of the battery's operation.

Another class of additives that is well suited for incorporation in the polymer fibers of the mats is glycol esters. These esters inhibit the growth of lead sulfate crystals as well as suppressing the generation of hydrogen and oxygen gas from the electrolysis of water in the electrolyte. Because they are esters however, they are prone to ester hydrolysis in the highly acidic environment of the sulfuric acid electrolyte and tend to have short lifetimes when added directly to the electrolyte. Incorporation of one or more types of glycol esters into the polymer fibers of the mat that makes contact with the electrolyte allows their replenishment in the electrolyte over a significantly longer duration of the battery's operation.

The additive-containing polymer fibers may be used in a variety of lead acid battery components. Examples of these components include pasting mats for a positive and/or negative electrode of the battery. For example, the additive-containing polymer fibers may be part of a spunbond mat that includes a sheath or series of pockets to hold an electrode active material of the lead acid battery. Further examples of these components include the separator that electrically insulates the positive and negative electrodes of the battery while permitting the migration of the balancing ions (e.g., sulfate and bisulfate ions) in the electrolyte. Still further examples of the components include a retainer/support mat for a separator made of different materials (e.g., a porous membrane or glass fibers). Still additional examples of the components include the additive-containing polymer fibers incorporated into the electrode active material to improve the strength and lengthen the lifetimes of the electrodes made with the materials. The additive-containing polymer fibers may be incorporated into the positive electrode active material, the negative electrode active material, or both the positive and negative electrode active materials.

Embodiments of the invention include a fiber-containing mat for a lead acid battery, where the mat has a plurality of polymer fibers. At least one additive is incorporated into at least a portion of the polymer fibers. The additive suppresses hydrogen evolution in the lead acid battery, and has a standard boiling point of 160° C. or more.

Embodiments of the invention also include a fiber-containing mat that acts as a gauntlet for holding an electrode active material in a lead acid battery. The fiber-containing mat includes a plurality of polymer fibers, and at least one additive incorporated into at least a portion of the polymer fibers. The at least one additive suppresses hydrogen evolution in the lead acid battery, and has a standard boiling point of 160° C. or more.

Embodiments of the invention further include fiber-containing mats for lead acid batteries that include a plurality of polymer fibers and at least one additive incorporated into at least a portion of the fiber-containing mat. The at least one additive suppresses hydrogen evolution in the lead acid battery, and has a standard boiling point of 160° C. or more. In some embodiments, the at least one additive is incorporated into a binder that holds together the plurality of fibers in the fiber-containing mat. In additional embodiments, the at least one additive is incorporated into at least a portion of the polymer fibers. In still further embodiments, the at least one additive is incorporated into both the binder and the polymer fibers.

Embodiments of the invention still further include a lead acid battery. The battery may include a positive electrode having a positive active material, and a fiber-containing gauntlet that holds the positive active material. The battery may also include a negative electrode that includes a lead alloy, and a separator that electrically insulates the negative electrode from the positive electrode. A plurality of polymer fibers is incorporated into at least one of the fiber-containing gauntlet or the separator, where the plurality of polymer fibers include at least one additive incorporated into at least a portion of the polymer fibers. The at least one additive suppresses hydrogen evolution in the lead acid battery, and has a standard boiling point of 160° C. or more.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### DETAILED DESCRIPTION OF THE INVENTION

Fiber-containing mats made from polymer fibers that incorporate one or more additives to improve the operational performance and lifetime of a lead acid battery are described. The polymer fibers may be made by a spunbond, meltblown, or spunlace process that uses a melted extrudate of the polymer into which the one or more additives are incorporated. The additives may be introduced (i) before the polymers are melted, (ii) after the polymer is melted but before it is extruded, (iii) after the melted polymer is extruded but before it is blown into a mat layer, and/or (iv) onto the mat layer of the polymer fibers. Depending on when the one or more additives are added to the polymer, the additives may be distributed throughout the bulk of the polymer fibers or located, primarily or exclusively, on the surface of the fibers.

The polymer fibers that incorporate the one or more additives may include a variety of thermoplastic polymers. Exemplary polymers include polyalkylene terephthalate polymers (e.g., polyethylene terephthalate, polybutylene terephthalate, etc.), and polyalkylene polymers (e.g., polyethylene, polypropylene, polybutylene, etc.), among other thermoplastic polymers. In some embodiments the polymer fibers include a blend of two or more types of thermoplastic polymers in each fiber. In additional embodiments, the fiber-containing mat includes a blend of fibers made from two or more different thermoplastic polymers (e.g., a first set of fibers made from polyethylene terephthalate and a second set of fibers made from polybutylene terephthalate). In still further embodiments the present polymer fibers may be blended with fibers that are not made from organic polymers (e.g., glass fibers, carbon fibers, mineral fibers, etc.).

The additives may include organic esters that are prone to rapidly hydrolyzing in the highly acidic environment of a sulfuric acid electrolyte used in the battery. The additives, which may include benzyl benzoate and glycol esters, improve the performance and lifetime of the battery by inhibiting sulfation and/or suppressing the generation of hydrogen and oxygen gas from the electrolysis of water in the electrolyte, among other benefits. By incorporating the additives into the polymer fibers of the fiber mats instead of adding them exclusively to the sulfuric acid electrolyte, they can be maintained at sufficient concentrations in the electrolyte over a longer period, in some instances even the lifetime of the battery.

In some embodiments, the fiber-containing mat is made primarily or exclusively by contact-adhesion of the polymer fibers containing the additive and no added binder is present. In additional embodiments, the fiber-containing mat also includes a binder that assists in holding the fibers together in the mat. Exemplary binder compositions used to make the binders include acrylic binder compositions, styrene acrylonitrile binder compositions, styrene butadiene rubber binder compositions, urea formaldehyde binder compositions, epoxy binder compositions, polyurethane binder compositions, phenolic binder compositions, and polyester binder compositions, among other types of binder compositions.

The fiber-containing mats made from polymer fibers with the incorporated additives may be used in a variety of components of a lead acid battery. For example, the fiber-containing mats may be used as a pasting mat that helps contain an electrode active paste in a battery electrode. The polymers used to make the fibers of the mat, as well as the compounds chosen for the additives, may be selected based on the composition of the electrode active paste. For example, a pasting mat that contacts a lead-oxide-containing positive electrode active paste in a positive electrode may use a different type and/or amount of additive than a pasting mat that contacts a lead-alloy-containing negative electrode active paste in a negative electrode. In additional examples, such as when the lead-acid battery is an absorbent-glass-mat battery, the polymer fibers having the additives may be blended with glass fibers in the separators that electrically insulate the battery electrodes while permitting the migration of sulfur-containing ions (e.g., sulfate ions) in the electrolyte between the electrodes. Alternatively, the separator can be made from the polymer fibers having the one or more additives. In still further examples, the polymer fibers with the additives may be incorporated into fiber-containing mats used as retainer/support mats that provide support and/or backing for another battery component. For example, in flooded lead acid batteries the separator may be a porous membrane that doesn't have enough rigidity to maintain a constant barrier between opposite electrodes. The present retainer/support mats can act as a backing for the membrane so that it maintains a fixed position between the electrodes in the electrolyte solution. Still further examples of the components include polymer fibers having the one or more additives used in the electrode active materials to improve the strength of the electrode plate.

The fiber-containing mats that include polymer fibers with the incorporated additives can be used in one or more components of the lead-acid battery. Embodiments include using a single fiber-containing mat in a lead acid battery, for example as a pasting mat for one of the electrodes, as the separator, or as a retainer/support mat. Embodiments further include using two fiber-containing mats with one or more of the incorporated additives in the battery, for example, as pasting mats for each of the electrodes. Embodiments still further include using three or more fiber-containing mats with one or more incorporated additives in the battery, for example as pasting mats for each of the electrodes as well as a separator or retainer/support mat.

### Exemplary Pasting Mats

Fiber-containing mats that include the polymer fibers with the one or more incorporated additives may be used in a variety of pasting mats that contact and contain electrode active material for one or both electrodes of a lead acid battery. In some embodiments the pasting mat is a single planar layer that contacts a single surface of the electrode. In additional embodiments, the pasting mat forms a pocket or sleeve that covers and contains multiple surfaces of the electrode active material. In still additional embodiments, the fiber containing mat is formed into a series of tubes arranged in a cartridge belt fashion that is sometimes referred to as a gauntlet.

Exemplary Pasting Mats for Plate Electrodes

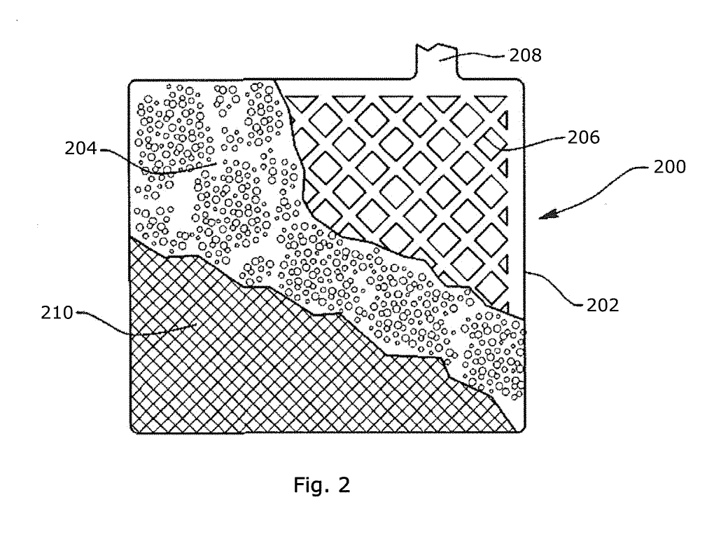

FIG. 2 shows a simplified cut-away schematic of an electrode 200 for a lead acid battery. The electrode includes a grid structure 202 that permits the conduction of electrons to and from an electrode active material 204. The grid structure 202 may be made from rods or strips of conductive materials such as lead alloys. Exemplary lead alloys include lead alloyed with one or more metals selected from antimony, calcium, and selenium, among other metals. For example the grid structure 202 may be made from a lead-antimony-calcium alloy. The grid structure 202 includes a tab 208 that can be electrically coupled to an external terminal of the battery, and a number of openings 206 between the grid lines. The openings 206 can be filled with the electrode active material 204 to increase the contact between the material and the grid structure 202. The electrode active material 204 may be covered with a pasting mat 210.

The pasting mat 210 may be made from the present fiber-containing mats that include polymer fibers having one or more additives. Exemplary polymer fibers used in the pasting mat include spunbond polymer fibers, meltblown polymer fibers, or spunlace polymer fibers, among other types of polymer fibers. The polymer fibers may be made from polyethylene terephthalate, polybutylene terephthalate, polyethylene, and polypropylene, among other thermoplastic polymers. Thus, a specific example of the polymer fibers used in the pasting mat 210 includes spunbond polyethylene terephthalate fibers. The polymer fibers may have an average fiber diameter ranging from 0.1 μm to 50 μm, and an average fiber length ranging from 0.1 mm to 25 cm (e.g., 1.5 mm to 60 mm; 3 mm to 25 mm; and 0.5 mm to 7 mm; among other exemplary length ranges).

In some embodiments, non-organic polymer fibers may be mixed with the plurality of polymer fibers having one or more additives. For example, the polymer fibers may be mixed with one or more types of fibers selected from glass fibers, mineral fibers, carbon fibers, among other types of non-organic polymer fibers.

The one or more additives in the polymer fibers may be incorporated into the melted polymer that is formed into the fibers. For example, when the polymer fibers are spunbond polymer fibers, meltblown polymer fibers, or spunlace polymers fibers, the one or more additives may be added to the melted thermoplastic polymer at one or more points in the production process. Exemplary introduction points for the one or more additives include (i) before the polymers are melted, (ii) after the polymer is melted but before it is extruded, (iii) after the melted polymer is extruded but before it is blown into a mat layer, and/or (iv) onto the mat layer of the polymer fibers. The one or more additives may be added in an amount ranging from 0.01 wt. % to 10 wt. % relative to the weight of the fiber-containing mat (e.g., the pasting mat 210). Additional exemplary weight percentage ranges for the one or more additives include 0.01 wt. % to 5 wt. % relative to the weight of the fiber-containing mat.

In some embodiments, the temperature of the melted polymer used to make the polymer fibers may range from 250° C. to 300° C. (e.g., 250° C. to 280° C.), and the one or more additives are selected with standard boiling points (i.e., the temperature at which boiling occurs under a pressure of 1 bar) that are compatible with the melting temperature of the polymer. Exemplary standard boiling points for the one or more additives may be 160° C. or more. Further examples include additives with standard boiling points of 200° C. or more, and 250° C. or more, among other ranges for the standard boiling point.

Exemplary additives incorporated into the polymer fibers may include one or more of an aromatic ester, a glycol ester, a phenolic aldehyde, an aromatic aldehyde, and wood flour, among other additives. Exemplary aromatic esters include benzyl benzoate, which inhibits sulfation when used as an additive in the paste of the lead acid battery. It also suppresses the evolution of hydrogen from the hydrolysis of water. Benzyl benzoate has a high boiling point (323° C.) relative to the melting temperatures of the polymers used to make the polymer fibers. Exemplary glycol esters include polyethylene glycol esters, which also suppress hydrogen evolution from the hydrolysis of water. Specific glycol esters can be selected that have a high boiling point relative to the melting temperatures of the polymers used to make the polymer fibers, as well as being chemically compatible with those polymers. Exemplary glycol esters include the commercially available TegMeR® 812. Exemplary phenolic aldehydes include vanillin. Exemplary aromatic aldehydes include one or more of furan-2-aldehyde, benzaldehyde, 2-hydroxybenzaldehyde, 2-methoxybenzaldehyde, 3-methoxybenzaldehyde, 4-methoxybenzaldehyde, 2,4-dimethoxybenzaldehyde, 2,5-dimethoxybenzaldehyde, 3,4-dimethoxybenzaldehyde, 3,5-dimethoxybenzaldehyde, and 2,3,4-trimethoxybenzaldehyde. Exemplary wood flour includes oak wood flour.

In some embodiments, a binder may be added to the polymer fibers having the one or more additives. Exemplary binder compositions used to make the binder include acrylic binder compositions, styrene acrylonitrile binder compositions, styrene butadiene rubber binder compositions, urea formaldehyde binder compositions, epoxy binder compositions, polyurethane binder compositions, phenolic binder compositions, and polyester binder compositions, among other binder compositions. The binder compositions are selected for efficient curing at temperatures that are compatible with the polymer fibers and the one or more additives incorporated therein. For example binder compositions may be selected that cure efficiently at temperatures of 200° C. or less. In some embodiments, at least one of the additives incorporated into the polymer fibers may also be added to the binder composition. In additional embodiments a plurality of additives may be split between the polymer fibers and the binder of the pasting mat 210. For example, a first additive may be incorporated into the polymer fibers while a second additive may be incorporated into the binder through its addition to the binder composition.

The composition of the electrode active material 204 varies depending on whether the electrode 200 is a positive electrode or a negative electrode. Both electrodes may be made by applying a wet paste of an electrode active material to the grid structure 202 followed by curing and drying the paste. In some embodiments, the pasting mat is placed on the wet paste to facilitate the removal of water from the paste during drying. In additional embodiments, the pasting mat is placed on the electrode active material after it has been cured and dried.

The paste of electrode active material may be made by milling and oxidizing lead metal (Pb) into oxidized lead powder, referred to as “leady-lead oxide”, that includes remnants of the lead metal (e.g., 20-30 wt. % Pb), and lead oxide (e.g., 70-80 wt. % lead oxide). The lead oxide may include lead in one or more degrees of lead oxidation, including lead monoxide (PbO), lead dioxide (PbO₂), and lead tetraoxide (Pb₃O₄). The leady-lead oxide is then formed into a slurry by mixing with water and sulfuric acid. The sulfuric acid converts a portion of the lead and lead oxides into lead sulfates that may include one or more of monobasic lead sulfate (PbOPbSO₄), tribasic lead sulfate (3PbOPbSO₄.H₂O), and tetrabasic lead sulfate (4PbOPbSO₄).

The sulfated lead oxide slurry can be differentiated into positive and negative electrode active materials by varying the curing and drying conditions after a paste of the material has been applied to the electrode's grid structure 202. For example, the positive electrode active material pasted onto the positive grid structure of the electrode may be cured under elevated temperature conditions in the presence of steam to form a combination of lead oxides and lead sulfates that more readily form lead dioxide (PbO₂) when the lead acid battery is charged. On the other hand, the negative electrode active material pasted onto the negative grid structure of the electrode is cured at room temperature in the absence of steam to form a combination of lead oxides and lead sulfates that more readily form lead metal (e.g., spongy lead) when the lead acid battery is charged.

The negative electrode active material may also include an expander added to the slurry that promotes the formation of high-surface area spongy lead when the lead acid battery is charged. The expander may include carbon black, barium sulfate (BaSO₄), and a lignosulfonate. Expanders are generally added in a range of 0.5% to 1.5% of the weight of the lead components of the negative electrode active material (e.g., 1 wt %). In further embodiments, the negative electrode active material may include a polymer that slows the shrinkage of the material and the disintegration of the negative electrode. Exemplary polymers may include polymerized alcohols (e.g., polyvinyl alcohol) and polyvinylpyrrolidone. When the polymer is electrically insulating, additional conductive material such as carbon black, graphite, and/or carbon nanotubes, may be added to make the negative electrode active material more electrically conductive. The polymer is generally added in a range of 0.01% to 2% of the weight of the lead components of the negative electrode active material.

In some embodiments, reinforcing fibers may be incorporated into the slurry of the electrode active material. Exemplary fibers may include one or more of glass fibers, mineral fibers, carbon fibers and polymer fibers. The polymer fibers may include one or more of polyester fibers, polypropylene fibers, acrylic fibers, and modacrylic fibers. Exemplary lengths of the fibers range from 1 to 6 mm.

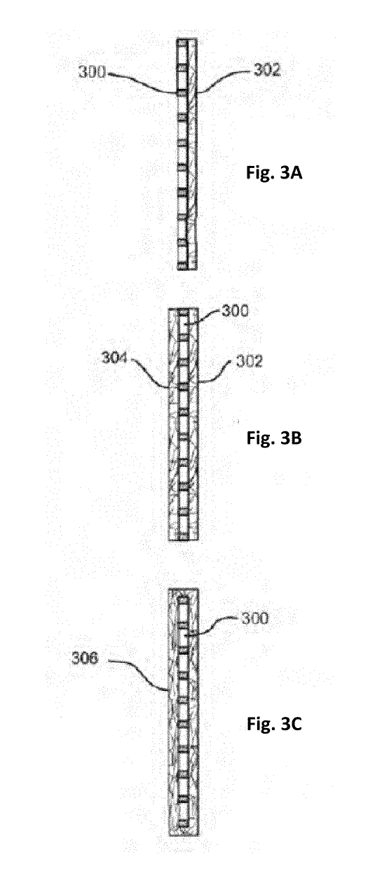

As shown in FIGS. 3A-3C, pasting mats may be attached to the battery electrodes in a number of ways. FIG. 3A shows a single pasting mat 302 attached to an electrode grid structure 300 that was pasted with electrode active material. FIG. 3B shows a first pasting mat 302 and a second pasting mat 304 attached on opposite sides of the electrode grid structure 300. FIG. 3C shows a pasting mat 306 in the shape of a pocket that envelops a plurality of the sides and edges of the electrode grid structure 300.

The pasting mats 302, 304, and 306 illustrated in FIGS. 3A-3C may be made from the same polymer fibers having one or more additives described above. In additional embodiments the pasting mats 304 and 306 attached to opposite sides of the electrode grid structure 300 in FIG. 3B may be made from different polymer fiber-containing mats. The differences between the pasting mats 304 and 306 may include differences in the composition of the polymer fibers used to make the mats and/or differences in the one or more additives incorporated into the polymer fibers. For example, when one of the pasting mats (e.g., pasting mat 304) is in direct contact with a separator (not shown) that includes an additive, then the pasting mat may incorporate less of that additive into its polymer fibers. However, the opposite mat (e.g., pasting mat 306) that is not in direct contact with a separator may be made with polymer fibers having higher concentrations of the one or more additives.

Because the pasting mats 302, 304, and 306 make direct contact with an electrode grid structure 300 that has pasted with an electrode active material, they may incorporate components to make them more electrically conductive. Examples of conductive materials incorporated into the pasting mats 302, 304, and 306 include one or more of graphite fibers, graphite particles, carbon black, and metal fibers and/or particles that are galvanically compatible with the lead-containing materials in the electrode grid structure 300 and electrode active materials.

Exemplary Pasting Mats for Gauntlet Electrodes

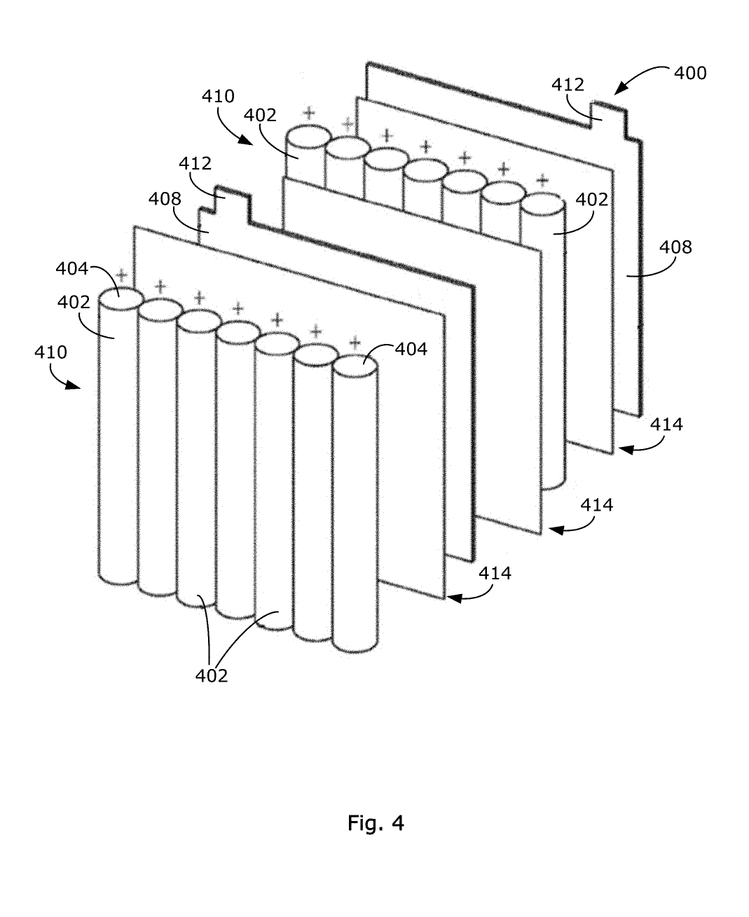

FIG. 4 shows a simplified schematic of a lead-acid battery cell 400 that includes pasting mat gauntlets 402 to hold and provide structural support for an electrode active material 404. Tubular gauntlet designs for mats in lead-acid batteries are also described in co-assigned U.S. patent application Ser. No. 15/136,707 filed Apr. 22, 2016 and titled “Gauntlet Lead-Acid Battery Systems”, the entire content of which is herein incorporated by reference for all purposes. The pasting mat gauntlets 402 filled with the electrode active material 404 form one of the electrodes 410 of the battery cell 400. Each pasting mat gauntlets 402 is made of individual tubes that are coupled together in a cartridge belt fashion to hold the electrode active material 404. The filled pasting mat gauntlets 402 are electrically connected to a terminal (not shown) of the battery cell 400 and electrically insulated from the other electrode 408 by separator 414. The pasting mat gauntlets 402 effectively function as one of the electrodes in the battery cell 400. In the embodiment shown in FIG. 4, the pasting mat gauntlets 402 hold a positive electrode active material 404 such as lead oxide PbO₂, and other electrode 408 is the negative electrode that is coupled to a negative terminal (not shown) of the lead-acid battery cell 400 through negative electrode tab 410. In other embodiments (not shown) the pasting mat gauntlets may be used to hold negative electrode materials, or both the positive and negative electrode materials.

The pasting mat gauntlets 402 may be made from a mat or fabric of polymer fibers having one or more additives. The polymer fibers and additives may be the same as described above for pasting mat 210 in FIG. 2. For example, the polymer fibers used to make pasting mat gauntlet 402 may include spunbond polymer fibers, meltblown polymer fibers, or spunlace polymer fibers, among other types of polymer fibers. The polymer fibers may be made from polyethylene terephthalate, polybutylene terephthalate, polyethylene, and polypropylene, among other thermoplastic polymers. The additives incorporated into the polymer fibers may include one or more of an aromatic ester (e.g., benzyl benzoate), a glycol ester (e.g., polyethylene glycol esters), a phenolic aldehyde (e.g., vanillin), an aromatic aldehyde (e.g., alkoxybenaldehydes), and wood flour (e.g., oak wood flour), among other additives. The one or more additives may be added in an amount ranging from 0.01 wt. % to 10 wt. % relative to the weight of the fiber-containing mat (e.g., the pasting mat 210). Additional exemplary weight percentage ranges for the one or more additives include 0.01 wt. % to 5 wt. % relative to the weight of the fiber-containing mat.

In some embodiments, the temperature of the melted polymer used to make the polymer fibers in the pasting mat gauntlets 402 may range from 250° C. to 300° C. (e.g., 250° C. to 280° C.), and the one or more additives are selected with standard boiling points (i.e., the temperature at which boiling occurs under a pressure of 1 bar) that are compatible with the melting temperature of the polymer. Exemplary standard boiling points for the one or more additives may be 160° C. or more. Further examples include additives with standard boiling points of 200° C. or more, and 250° C. or more, among other ranges for the standard boiling point.

In some embodiments, a binder may be added to the polymer fibers having the one or more additives that are used to make the pasting mat gauntlets 402. Exemplary binder compositions used to make the binder include acrylic binder compositions, styrene acrylonitrile binder compositions, styrene butadiene rubber binder compositions, urea formaldehyde binder compositions, epoxy binder compositions, polyurethane binder compositions, phenolic binder compositions, and polyester binder compositions, among other binder compositions. The binder compositions are selected for efficient curing at temperatures that are compatible with the polymer fibers and the one or more additives incorporated therein. For example binder compositions may be selected that cure efficiently at temperatures of 200° C. or less. In some embodiments, at least one of the additives incorporated into the polymer fibers may also be added to the binder composition. In additional embodiments a plurality of additives may be split between the polymer fibers and the binder of the pasting mat 210. For example, a first additive may be incorporated into the polymer fibers while a second additive may be incorporated into the binder through its addition to the binder composition. In additional examples, the binder may contain the first additive while the polymer fibers lack any additive.

An electrically-conductive material may be incorporated into the pasting mat gauntlets 402 to increase electrical conductivity in the electrode 410. The electrically-conductive material may take the form of electrically-conductive fibers (e.g., graphite fibers, metal fibers, electrically-conductive polymer fibers, etc.) blended with the polymer fibers containing the one or more additives. In additional embodiments, the electrically conductive material may be added to the polymer melt that is used to make the polymer fibers with the one or more additives. For example, particles of conductive material (e.g., carbon black, graphite, graphene, etc.) may be added to the polymer melt in an amount ranging from 1 wt. % to 30 wt. % of the weight of the melted polymer. In still additional embodiments, the electrically-conductive material may be part of a binder that is used to help hold together the polymer fibers in the pasting mat gauntlets 402.

Examples of electrically-conductive material used in the binder include conductive carbon particles such as carbon black (e.g., acetylene black), graphite, graphene, and electrically conductive polymers. Exemplary levels of the electrically-conductive material range from 1 wt. % to 10 wt. % (e.g., 2 wt. % to 6 wt. %) of the total weight of the empty pasting mat gauntlet 402 (i.e., the gauntlet without the electrode active material). In some embodiments, the amount of electrically-conductive material added to the pasting mat gauntlet 402 is determined by a target electrical conductivity for the gauntlet. For example, electrically-conductive additives may be added in an amount that gives the pasting mat gauntlet 402 an electrical conductivity of 110 Ohms or less, 105 Ohms or less, 104 Ohms or less, 103 Ohms or less, etc.

The electrode active materials used in the electrodes 408 and 410 may be the same as those described in FIG. 2 above. Specifically the positive electrode active material used in electrode 410 may be a combination of lead oxides and lead sulfates that more readily form lead dioxide (PbO₂) when the lead acid battery is charged. The negative electrode active material used in electrode 408 may be a combination of lead oxides and lead sulfates that more readily form lead metal (e.g., spongy lead) when the lead acid battery is charged.

The series of tube-shaped bags that form the pasting mat gauntlets 402 increases the surface area of the electrode active material available for electro-chemical reactions relative to monolithic plates. The gauntlets 402 also maintain the structural stability of the electrode when the electrode active material flakes or sheds after a number of charging and discharging cycles. Thus for some lead-acid battery applications, the tubular design of pasting mat gauntlets 402 provides better battery performance and a longer lifetime than a monolithic plate design.

### Exemplary Lead-Acid Cell

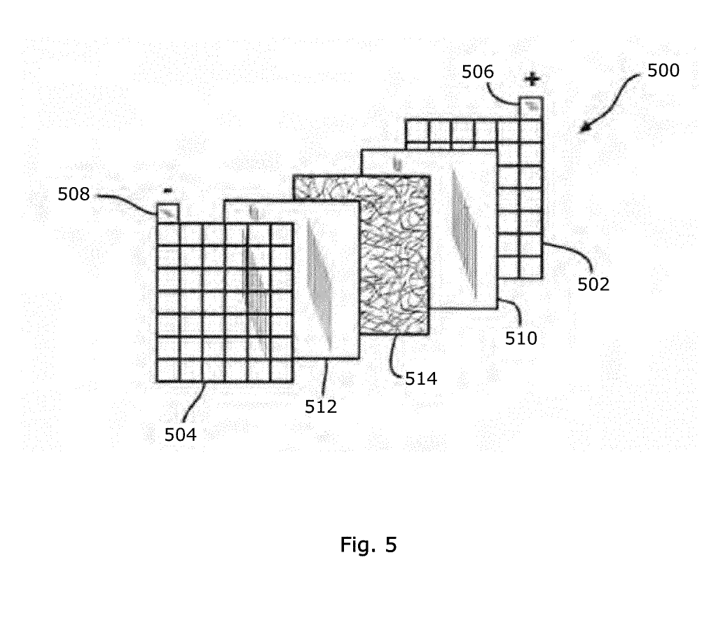

FIG. 5 shows an exploded view of selected components of a lead acid cell 500. The lead-acid cell 500 can provide an electromotive force (emf) of about 2.1 volts and three such cells connected in series can make a lead-acid battery with an emf of about 6.3 volts. Lead acid-batteries with higher voltages may be obtained by connected more cells 500 in series. For example connecting six cells 500 in series can make a lead-acid battery with an emf of about 12.6 volts, and so on. The lead acid cell 500 may include a positive electrode 502, including positive active material (not shown) pasted on grid (shown), and a negative electrode 504, including negative active material (not shown) pasted on a grid (shown), that may be made from grid structures and electrode active materials described above. The positive electrode 502 may also include a positive tab 506 that is electrically coupled to a positive terminal (not shown) of the cell or battery and the negative electrode 504 may include a negative tab 508 that is electrically coupled to a negative terminal (not shown) of the cell or battery.

The lead acid cell 500 may also include at least one component made from the present mats that include polymer fibers having one or more additives, or include a binder which contains one or more additive and bonds the polymer fibers together to form a mat. For example, the lead acid cell 500 may include a first pasting mat 510 in contact with the positive electrode 502, a second pasting mat 512 in contact with the negative electrode 508 made from the present mats made from polymer fibers having one or more additives. In some embodiments, the lead acid cell 500 is an AGM lead acid cell and the separator 514 is made from a glass-fiber mat that include glass fibers operable to absorb the cell electrolyte (e.g., an aqueous sulfuric acid electrolyte). In additional embodiments, the lead acid cell 500 is a flooded lead acid cell, and the separator 514 may be a sheet of material made from paper, rubber, or organic polymers that is in contact on one or more sides with one or more retainer/support mats made from the present mats with polymer fibers having one or more additives. In an exemplary flooded lead acid cell, the one or more retainer/support mats may be made entirely from the polymer fibers having the one or more additives, or they may also include glass fibers blended with the polymer fibers.

First pasting mat 510 may be impregnated or saturated with the positive electrode active material pasted on positive electrode 502 such that the first pasting mat 510 is partially or fully disposed within the positive electrode active material. Impregnation or saturation of the positive electrode active material within the first pasting mat 510 means that the active material penetrates at least partially into the first pasting mat. For example, first pasting mat 510 may be fully impregnated with the positive electrode active material so that the mat 510 is fully buried within the positive electrode active material (e.g., fully buried within the lead oxide paste). Fully burying the pasting mat 510 within the positive electrode active material means that the mat 510 is entirely disposed within the positive electrode active material. In examples, first pasting mat 510 may be disposed within the positive electrode active material up to about a depth “X” of about 20 mils (i.e., 0.020 inches) from an outer surface of the positive electrode 502. In other examples, the first pasting mat 510 may rest atop the positive electrode active material so that the mat 510 is impregnated with very little of the active material. Embodiments include the first pasting mat 510 being impregnated with the positive electrode active material such that the outer surface of the mat 510 forms or is substantially adjacent the outer surface of the positive electrode 502. In other words, the positive electrode active material may fully penetrate through the first pasting mat 510 such that the outer surface of the positive electrode 502 is a blend or mesh of the positive electrode active material and the fibers of the first pasting mat 510.

Similarly, the second pasting mat 512 is shown positioned adjacent to a surface of the negative electrode 504 may be arranged and/or coupled with the negative electrode in a configuration similar to that described above for the first pasting mat 510 with respect to the positive electrode 502. For example, the second pasting mat 512 may be disposed partially or fully over the surface of the negative electrode 504 so as to partially or fully cover the surface, or may be positioned on an inner surface of the negative electrode 504 (i.e., adjacent separator 514) instead of the shown outer surface configuration, and/or may be impregnated or saturated with the negative electrode active material such that the second pasting mat 512 is partially or fully disposed within the active material. Like the first pasting mat 510, the second pasting mat 512 may provide additional support to help reduce the negative effects of shedding particles of the negative electrode active material caused by repeated charge and discharge cycles of lead acid cell 500.

As noted above, the mats made from polymer fibers having one or more additives may also include electrically conductive materials that permit the mat to provide additional electrically conductive pathways to the tabs 506 and 508 of the lead acid cell 500. These electrically conductive materials may include electrically conductive fibers (e.g., graphite fibers, metal fibers, electrically-conductive polymer fibers, etc.) and/or electrically conductive particles (e.g., carbon black) incorporated into one or more of the fiber-containing mats. For example, the first and/or second pasting mats 510 and 512 may include a conductive material incorporated into the fiber-mat. This permits an additional electrical conduction pathway around the outer surface of the electrodes 502 and/or 504 to the electrode tabs 506 and 508, respectively. In additional examples, the one or more retainer/support mat components of separator 514 may include electrically conductive materials that create an additional electrical conduction path for electrons traversing the height of the positive and/or negative electrode 502 and 504, respectively. The separator 514 may also include an electrically insulating layer (e.g., a microporous sheet of electrically insulating material) that prevents direct electrical conduction between the positive and negative electrodes 502 and 504 that would create a short circuit inside the lead acid cell 500.

### Exemplary Lead Acid Batteries

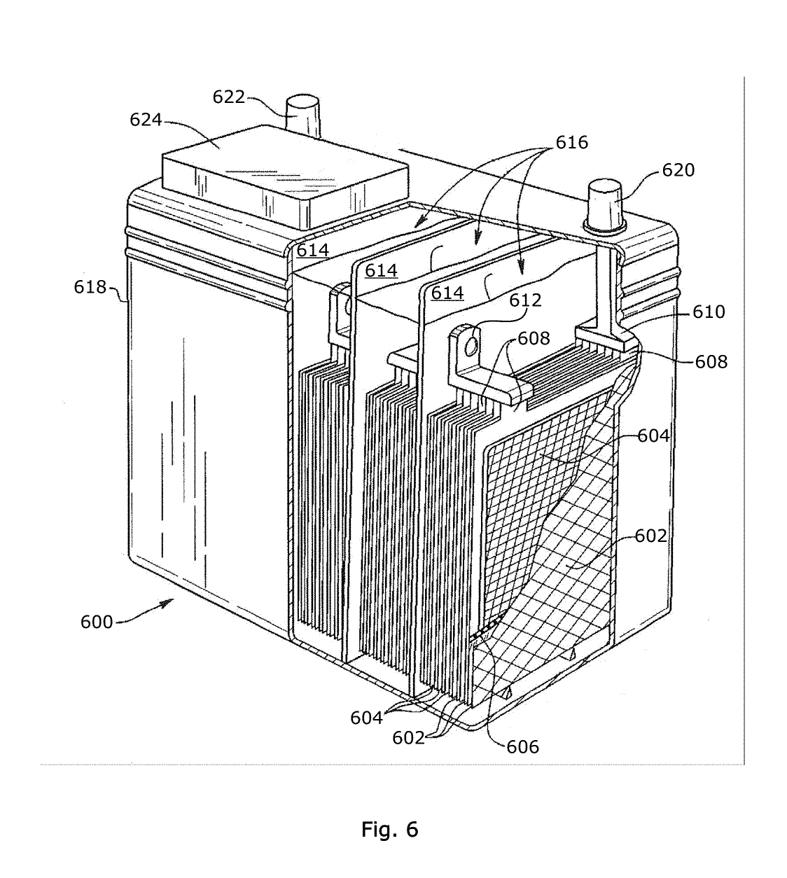

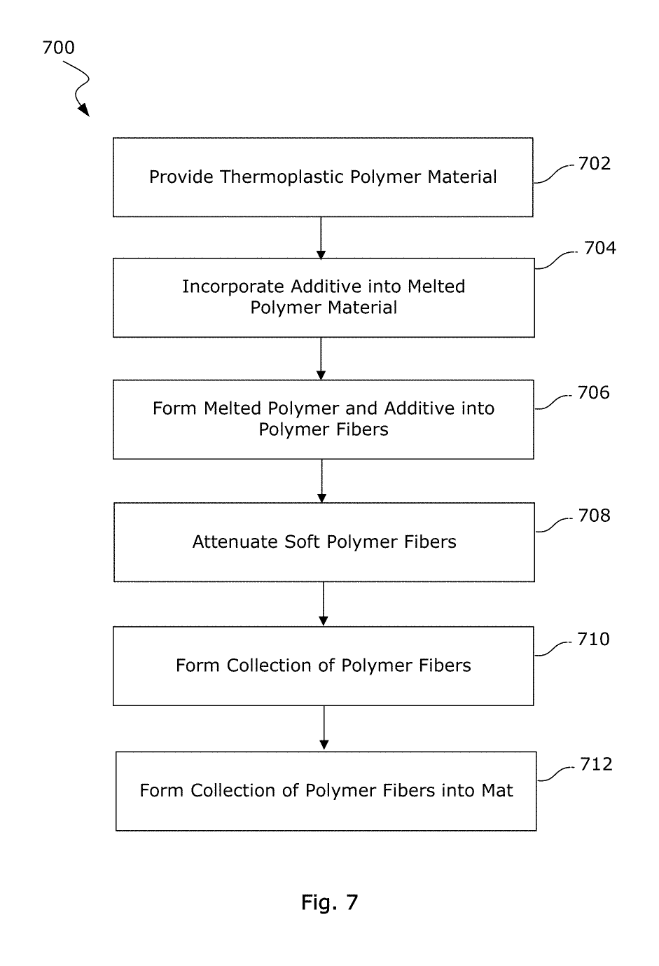

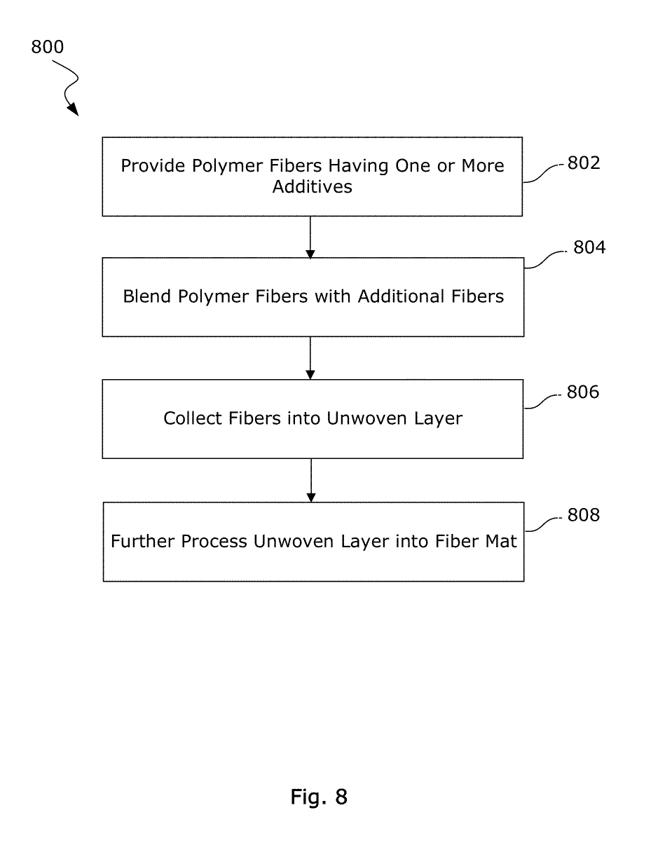

FIG. 6 shows a cut-away view of an example of a flooded lead acid battery 600 that incorporates the present mats made from polymer fibers having one or more of the above-described additives. In alternative embodiments, the present mats may include a binder that contains the one or more additives and holds together the polymer fibers in the mats. The battery 600 includes multiple lead-acid cells that include positive electrodes 602 and negative electrodes 604 that are electrically isolated from each other by separators 606 which may include one or more retainer/support mats. The positive and negative electrodes 602 and 604 include tabs 608 for the conduction of electrons between the electrodes and the battery's positive and negative terminals 620 and 622. The electrical connection between the tabs 608 and terminals 620 and 622 is made through connectors 610 and 612. In the embodiment shown, sub-groups of approximately six lead-acid cells are separated by partition walls 614 that prevent the seepage of the liquid electrolyte 616 between the partitioned subgroups of cells.

The lead acid cells and electrolyte are enclosed by the battery case 618 that keeps the electrolyte 616 from spilling out of the battery 600 as well as provides structural support for the partition wall 614, connectors 610 and 612, and terminals 620 and 622, among other components of the battery. The battery case 618 may be made from polymers that resist corrosion from the electrolyte (e.g., polypropylene and polycarbonate polymers). In the embodiment shown, battery 600 includes a cover 624 that conceals ports (not shown) that allow additional water to be added to the battery 600 as well as gases such as hydrogen and oxygen gas to vent from the battery. In alternate embodiments (not shown) such as AGM lead-acid batteries, the ports may be replaced by one-way valves that permit the venting of gases from the battery but do not allow water to be added to the battery.

The present mats made from polymer fibers that include one or more additives may be used in a variety of components for battery 600, including one or more of the pasting mats for the electrodes 602 and 604, and as retainer/support mats for the separators 606. Embodiments include a battery 600 with a pasting mat coupled to the positive electrode 602, the negative electrode 604, or both electrodes. Embodiments also include a battery 600 with the present mats made from polymer fibers having one or more additives as the retainer/support mats. Embodiments still further include a battery 600 with the present mats as pasting mats for either one or both of the electrodes 602 and 604, as well as the retainer/support mats of the separators 606. Embodiments yet further include an AGM battery 600 with glass fibers used in the separators 606. Embodiments still also include a separator mat made from polymer fibers having the one or more additives that are incorporated into valve-regulated lead-acid batteries (i.e., VRLA batteries).

Exemplary electrolyte 616 for the lead-acid battery 600 include an aqueous solution of sulfuric acid. For lead-acid batteries, the effectiveness of the electrolyte is commonly assessed by measuring its specific gravity. When the lead-acid battery 600 is in a fully-charged state, the specific gravity typically ranges from 1.260 to 1.300 g/cm³ at 15° C. In a discharged state, the specific gravity drops to about 1.100 g/cm³ as an increasing amount of the sulfate ions have moved from the electrolyte 616 to help form lead sulfate on the electrodes 602 and 604.

### Exemplary Methods of Making Polymer Fiber Mats

The present mats are made from polymer fibers in which one or more additives incorporated that help enhance the performance and operational lifetime of lead-acid batteries. As noted above the one or more additives may be incorporated into the fibers at a time when the starting thermoplastic polymers are melted so that the one or more additives may be mixed with the polymer melt. The additive-containing polymer melt may then be formed into mats using one or more types of spunlaid methods such as a spunbond method or meltblown method, among other method of making the mat. In additional embodiments of the methods, the mat may be made by spunbonding, meltblowning, etc., regular polymer fibers (with or without one or more additives). A binder may then be applied to the mat followed by drying and curing the mat. The one or more additives may be added into the binder so it is a component of the mat. Thus, the one or more additives may be added into the polymer fibers, or binder which bonds the polymer fibers to form a mat or both the fibers and binder. The section below describes some exemplary methods by which the combination of the melted polymer and one or more additives are formed into fibers and the present mats.

### Spunbond Formation Methods

Exemplary methods of making the present mats from polymer fibers having one or more additives include spunlaid methods such as spunbond, meltbond, and/or spunlace production methods. An exemplary spunbond method 700 may include providing thermoplastic polymer starting material 702 (e.g., pellets of the polymer starting material). The thermoplastic polymer starting material may include fibers and/or particles of the thermoplastic polymer that will make up the bulk of the polymer fibers that are used in the mat. Exemplary thermoplastic polymers used as the starting polymer may include one or more of polyethylene terephthalate, polybutylene terephthalate, polyethylene, and polypropylene, among other thermoplastic polymers. As noted above, exemplary ranges for the melting point of the thermoplastic polymer include (i) 250° C. to 300° C., and (ii) 250° C. to 280° C., among other ranges.

In the embodiment shown, step 704 has one or more additives incorporated into the melted thermoplastic polymer before the combination is formed into polymer fibers. The one or more additives may be added to the melted thermoplastic polymer after the polymer is melted but before the melted polymer is extruded, after the melted polymer is extruded but before it is blown into the fibers of the mat layer, and/or after the melted polymer has been blown into the fibers of the mat layer but before they polymer fibers have fully hardened. In additional embodiments (not shown), the one or more additives may be added before the polymers are melted (e.g., spraying, pouring, and/or dipping the additive onto the solid polymers), or after the polymer fibers have been cooled and hardened into the mat.

As noted above, exemplary additives incorporated into the polymer fibers may include one or more of an aromatic ester (e.g., benzyl benzoate), a glycol ester (e.g., polyethylene glycol esters), an aromatic ester (e.g., vanillin), an (e.g., alkoxybenaldehydes), and wood flour (e.g., oak wood flour), among other additives. The one or more additives may be added in an amount ranging from 0.01 wt. % to 10 wt. % relative to the weight of the fiber-containing mat. Additional exemplary weight percentage ranges for the one or more additives include 0.01 wt. % to 5 wt. % relative to the weight of the fiber-containing mat. The additives may be selected to have standard boiling points compatible with the melting points of the thermoplastic polymer to which they are added. Exemplary standard boiling points for the one or more additives may be 160° C. or more. Further examples include additives with standard boiling points of 200° C. or more, and 250° C. or more, among other ranges for the standard boiling point.

The combined melted thermoplastic polymer and one or more additives are then formed into fibers at step 706. The formation process may include extruding the additive-containing thermoplastic polymer melt through a pump and (optionally) a filter to supply the melt under pressure to a spinneret containing a plurality of holes. The additive-containing thermoplastic polymer forms the polymer fibers as it pushes through the holes in the spinneret. The polymer fibers having one or more additives emerging from the holes of the spinneret may be cooled and drawn by air (e.g., quench air) flowing in a direction towards a conveyor belt where the fibers collect to form the mat.

In the embodiment shown, the fibers emerging and drawn from the spinneret are further subjected to an attenuation step 708 where the fibers are further stretched and pulled closer together. Subsequently, the attenuated polymer fibers having the one or more additives are dispersed onto a conveyor belt that forms the fibers into collection of nonwoven fibers 710. In some embodiments, the attenuated polymer fibers are dispersed directly onto the conveyor belt by the force of gravity and/or the aid of vacuum suction applied from below an air-permeable conveyor belt. In additional embodiments, the attenuated polymer fibers may contact one or more dispersion plates (e.g., rotary plates) that provide more control over the patterns in which the fibers are dispersed on the conveyor belt.

The polymer fibers dispersed on the conveyor belt may undergo further processing to form the mat or fabric 712. In some embodiments, the polymer fibers dispersed onto the conveyor belt are soft enough to stick to each other without further processing (i.e., autogenous bonding) and the further processing may be limited to cooling and hardening the fibers into the final mat. In additional embodiments, the polymer fibers are calendared, needled, and/or contacted with a binder composition to form the fibers into the final mat. For example, the collection of polymer fibers on the conveyor belt may be needled, dip coated through a binder composition, and heated to cure the binder before being formed into the final mat containing the polymer fibers with the one or more additives. In this case, the additive can be added into the binder instead of in the polymer fibers or can be added in both the binder and the polymer fibers.

Methods of making meltblown fibers may be similar to the above-described method of making spunbond fibers. The meltblown methods may differ in the degree to which the polymer fibers are pulled and stretched to form meltblown polymer fibers having average fiber diameters that are smaller than average fiber diameters of spunbond polymer fibers. For example, a mat made with spunbond polymer fibers may have fiber diameters ranging from 1 μm to 50 μm with an average fiber diameter ranging from 15 μm to 35 μm. Alternatively, a mat made with meltblown polymer fibers may have fiber diameters ranging from 0.1 μm to 15 μm with an average fiber diameter ranging from 2 μm to 6 μm.

### Blended Fiber Formation Methods

Embodiments of the present polymer fiber mat formation methods also include mats made from a combination of (i) polymer fibers containing the one or more additives and (ii) one or more types of additional fibers such as glass fibers, carbon fibers, and/or polymer fibers. In some embodiments the additional fibers may have been treated (e.g., sized) with the one or more additives contained in the polymer fibers. Details about the additional fibers treated with the one or more additives can be found in co-assigned U.S. patent application titled “Fiber-Containing Mats With Additives for Improved Performance of Lead Acid Batteries”, filed the same day as the present Application, and whose entire contents is herein incorporated by reference for all purposes.

Embodiments of the mat formation methods 800 include providing the polymer fibers (e.g., continuous fibers, chopped fibers, etc.) having the one or more additives 802. The polymer fibers may be pre-made with the one or more additives incorporated therein using a standard fiber production method. The polymer fibers are then mixed with the other types of fibers to form a blend of two or more types of fibers 804. In some examples, the polymer fibers may be chopped to improve their mixing with other types of fibers. The blending may occur before the fibers are arranged as a layer, or as the fibers are collected together on a conveyor belt or some other platform to form an unwoven layer in step 806.

The blend of (i) the polymer fibers having the one or more additives and (ii) the one or more types of additional fibers may be further processed to hold the fibers together in step 808. The further processing may include calendering, needling, and/or contacting the fiber layer with a binder composition. For example, a binder composition may be sprayed or dip coated on the fiber layer followed by heating and/or drying to cure the binder. The cured mat includes the binder helping to hold together the blend of the polymer fibers having the one or more additives and the one or more types of additional fibers. In some embodiments the additives incorporated into the polymer fibers may also be incorporated into the binder. In additional embodiments, the one or more additives may be incorporated into the binder and not the polymer fibers.

### EXPERIMENTAL

Cathodic voltammetry measurements were taken on exemplary additives in aqueous sulfuric acid solutions to stimulate their impact on the electrochemical reactions in lead-acid batteries. In Examples 1 and 3, the impact of a glycol ester additive is evaluated while in Examples 2 and 4 the impact of a vanillin additive is evaluated. In Examples 1 and 2, the cathodic voltammetry measurements show that both additives are capable of suppressing hydrogen gas (H₂(g)) evolution and water loss from a lead-acid battery to a significantly greater extent than control samples of the sulfuric acid electrolyte that lack the additive. In Examples 3 and 4, both additives showed selectivity values of significantly greater than 1, indicating their ability to suppress the effects of antimony in a lead-acid battery, and therefore suppress water loss reduction where antimony is present in the battery. Thus, the additives are beneficial for many types of deep-cycle lead-acid batteries that incorporate a significant amount of antimony in the electrode plates to improve the cycle life of the battery.

### EXAMPLE 1

Electrochemical Compatibility (ECC) tests by direct addition can be conducted to evaluate the impact of TegMeR® 812 (from Halister). The hydrogen evolution potential can be tested using the established Electrochemical Compatibility (ECC) test as described in Battery Counsel International's Technical Manual BCIS-03A, Rev. September 09, for testing the effect of additives on the electrochemistry of Pb/PbSO₄/PbO₂ electrode systems. For the testing, the aqueous sulfuric acid can have a specific gravity of 1.210 (about 28.9 wt. % H₂SO₄ in water). In this method, the quantity of the additive (e.g., TegMeR® 812) is known and can be changed easily. The hydrogen evolution potential of the glycol ester additive can be compared with a control sample of the sulfuric acid electrolyte.

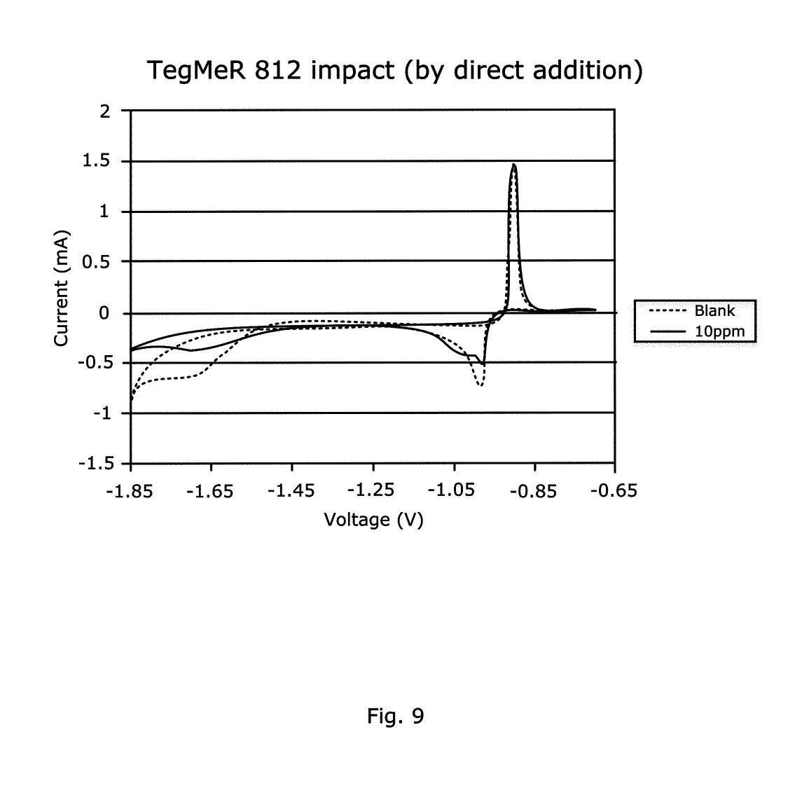

Cathodic voltammetry scans can be performed as follows: First, a 100 ml sample of sulfuric acid (specific gravity of 1.210 or 28.9 wt. % H₂SO₄ in water) was added into the glass cell and a cathodic scan was performed (scanned curve labeled “Blank” in FIG. 9). Next, a 1 ml dose of the additive solution can be added into the glass cell so the additive has the designated concentration, for example, 10 ppm. Then a cathodic scan may be performed (scanned curve labeled “10 ppm” in FIG. 9). The rotation rate of the scan may be 1000 rpm with a scan rate of 3.33 mV/sec. The scan range may be −700 mV to −1850 mV.

FIG. 9 shows the scan plot of current (in milliamps) versus voltage difference (in Volts) for the glycol ester additive and Blank samples. The plot shows the glycol ester additive (i.e., 10 ppm) shifts the hydrogen evolution potential to a more negative value. Looking at the hydrogen evolution maximum current at −1.85V, “10 ppm” shows −382.5 uA, a reduction of 57.3% from the Blank sample (−894.9 uA). This demonstrates that the glycol ester additive suppresses hydrogen evolution and reduces water consumption compared to the aqueous sulfuric acid Blank. Thus, the glycol ester additive is effective for reducing water loss for a lead-acid battery.

### EXAMPLE 2

Electrochemical Compatibility (ECC) tests by direct addition can be conducted to evaluate the impact of vanillin. The hydrogen evolution potential can be tested using the established Electrochemical Compatibility (ECC) test as described in Battery Counsel International's Technical Manual BCIS-03A, Rev. September 09, for testing the effect of additives on the electrochemistry of Pb/PbSO₄/PbO₂ electrode systems. For the testing, the aqueous sulfuric acid can have a specific gravity of 1.210 (about 28.9 wt. % H₂SO₄ in water). In this method, the quantity of the additive (e.g., vanillin) is known and can be changed easily. The hydrogen evolution potential of the vanillin additive can be compared with a control sample of the sulfuric acid electrolyte.

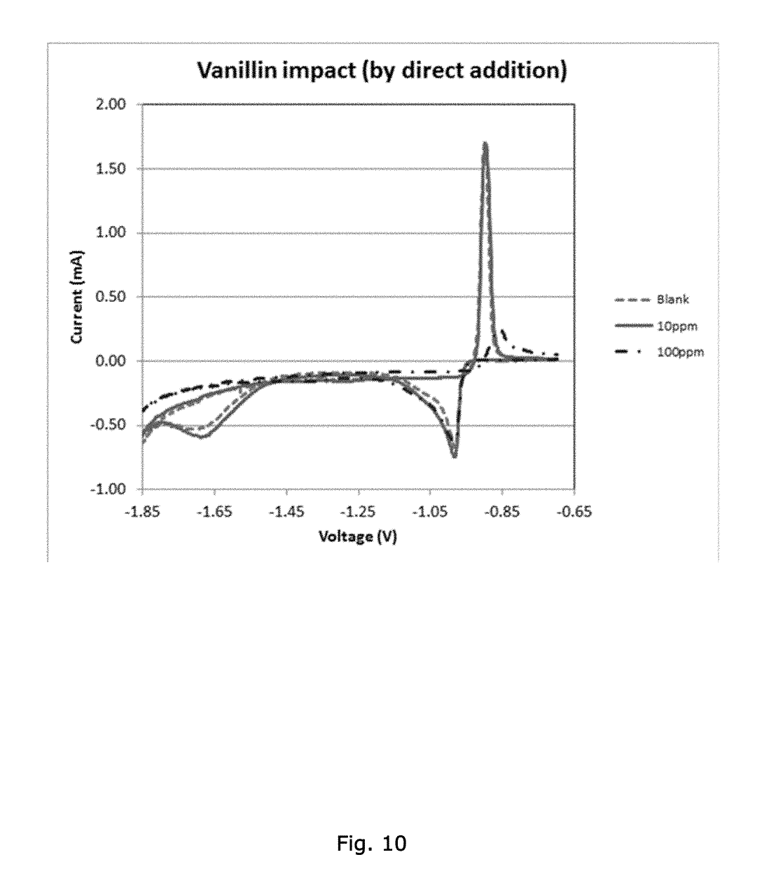

Cathodic voltammetry scans can be performed as follows: First, a 100 ml sample of sulfuric acid (specific gravity of 1.210 or 28.9 wt. % H₂SO₄ in water) was added into the glass cell and a cathodic scan was performed (scanned curve labeled “Blank” in FIG. 10). Next, a 1 ml dose of the additive solution can be added into the glass cell so the additive has the designated concentration of 10 ppm. A cathodic scan was performed (scanned curve labeled “10 ppm” in FIG. 10). Finally, a 10 ml dose of the additive solution can be added into the glass cell so that the additive has the designated concentration of 100 ppm. Cathodic scans may then be performed (scan curve labeled “100 ppm” in FIG. 10). The rotation rate of the scan may be 1000 rpm with a scan rate of 3.33 mV/sec. The scan range may be −700 mV to −1850 mV.

FIG. 10 shows the scan plot of current (in milliamps) versus voltage difference (in Volts) for the vanillin additive and Blank samples. The plot shows the vanillin additive (i.e., 10 ppm and 100 ppm) shifts the hydrogen evolution potential to a more negative value. This demonstrates that the vanillin additive suppresses hydrogen evolution and reduces water consumption compared to the aqueous sulfuric acid Blank. Thus, the vanillin additive is effective for reducing water loss for a lead-acid battery.

### EXAMPLE 3

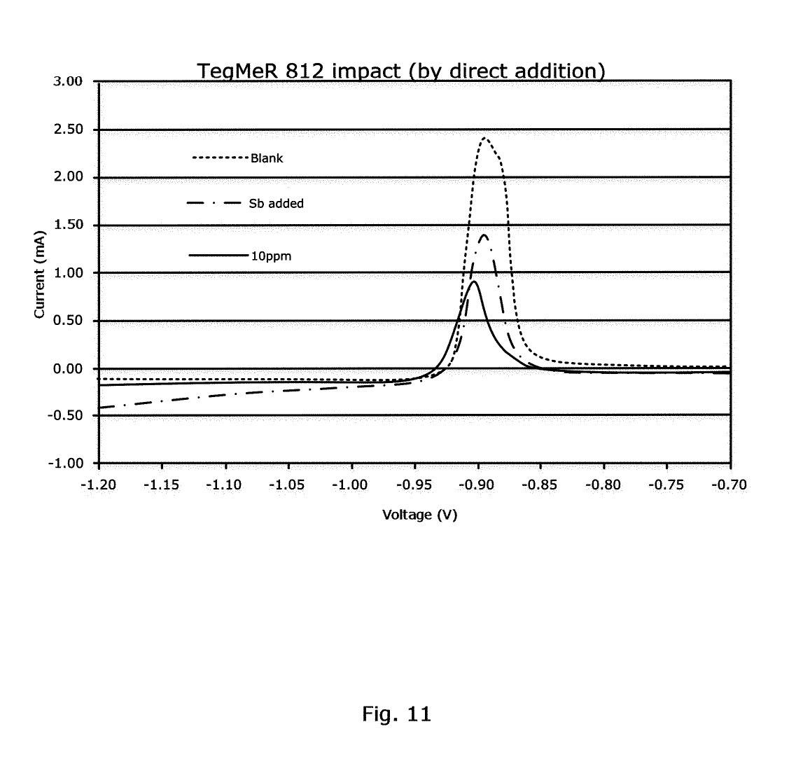

An antimony suppression test (AST) may be conducted according to the procedure described in Böhnstedt, W.; Radel, C.; Scholten, F. “Antimony poisoning in lead-acid batteries”, Journal of Power Sources, Volume 19, Issue 4, p. 307-314. The AST is a test to check the impact of an additive on hydrogen evolution when antimony (Sb) is present. This is the case for most deep cycle batteries, where antimony is added in the plates to increase the cycle life of the battery. However, water loss increases significantly due to the addition of antimony, and it is a goal to reduce the hydrolytic water loss in lead-acid batteries due to the presence of antimony. The AST test procedure includes three linear scans −1200 to −700 mV after 15 min. maintained at −1200 mV. The first scan is Blank (100 mL electrolyzed 1.21 sg H₂SO₄) scan. The second scan is with addition of Antimony (1 mL of 1000 ppm Sb added into 100 mL of H₂SO₄, so the Sb level is ˜10 ppm). The third scan is with addition of the additive, for example, TegMeR® 812. All three scans are plotted as shown in FIG. 11.

Selectivity is calculated from peak H₂ current and discharge capacities for the scans with Sb and with Sb plus additive according the equation:

$$Selectivity = \frac{( H 2 current with Sb ) \text{/} ( H 2 current with additive )}{( Capacity with additive ) \text{/} ( capacity of blank )}$$

A larger selectivity indicates better performance in terms of water reduction. The selectivity is calculated to be ˜2.38. This is significantly larger than 1 and indicates that the addition of TegMeR® 812 helps reduce water loss in the presence of antimony as well. Combining Examples 1 and 3, TegMeR® 812 is shown to be effective to reduce water loss with and without the presence of antimony, suggesting that the additive is effective in various applications, such as automobile and deep cycle applications.

### EXAMPLE 4

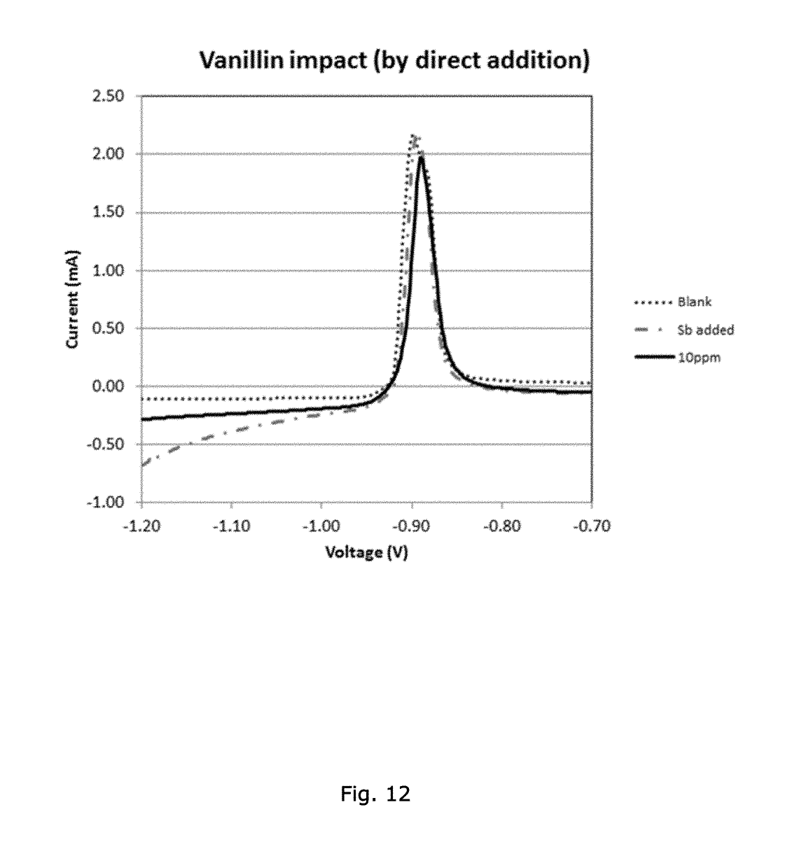

Another AST test procedure may be conducted according to the same procedure described in Example 3 to evaluate the impact of a different additive vanillin. The tests may include three linear scans −1200 to −700 mV after 15 min. maintained at −1200 mV. The first scan is Blank (100 mL electrolyzed 1.21 sg H₂SO₄) scan. The second scan is with addition of Antimony (1 mL of 1000 ppm Sb added into 100 mL of H₂SO₄, so the Sb level is ˜10 ppm). The third scan is with addition of the vanillin additive. All three scans are plotted as shown in FIG. 12.

Selectivity is calculated from peak H₂ current and discharge capacities for the scans with Sb and with Sb plus additive according the equation:

$$Selectivity = \frac{( H 2 current with Sb ) \text{/} ( H 2 current with additive )}{( Capacity with additive ) \text{/} ( capacity of blank )}$$

A larger selectivity indicates better performance in terms of water reduction. The selectivity is calculated to be ˜2.36. This is significantly larger than 1 and indicates that the addition of vanillin additive helps reduce water loss in the presence of antimony as well. Combining Examples 2 and 4, vanillin is shown to be effective to reduce water loss with and without the presence of antimony, suggesting that the additive is effective in various applications, such as automobile and deep cycle applications.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the additive” includes reference to one or more additives and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A fiber-containing mat for a lead acid battery, the mat comprising:
a plurality of polymer fibers; and
at least one additive incorporated into at least a portion of the polymer fibers, wherein the at least one additive suppresses hydrogen evolution in the lead acid battery, and wherein the at least one additive has a standard boiling point of 160° C. or more.

2. The fiber-containing mat of claim 1, wherein the at least one additive has a standard boiling point of 200° C. or more.

3. The fiber-containing mat of claim 1, wherein the at least one additive has a standard boiling point of 250° C. or more.

4. The fiber-containing mat of claim 1, wherein the plurality of polymer fibers are selected from the group consisting of polyethylene terephthalate fibers, polybutylene terephthalate fibers, polyethylene fibers, and polypropylene fibers.

5. The fiber-containing mat of claim 1, wherein the plurality of polymer fibers comprise polyethylene terephthalate fibers.

6. The fiber-containing mat of claim 1, wherein the plurality of polymer fibers are spunbond polymer fibers.

7. The fiber-containing mat of claim 1, wherein the plurality of polymer fibers are meltblown polymer fibers.

8. The fiber-containing mat of claim 1, wherein the plurality of polymer fibers are spunlace polymer fibers.

9. The fiber-containing mat of claim 1, wherein the mat further comprises glass fibers mixed with the plurality of polymers fibers.

10. The fiber-containing mat of claim 1, wherein the at least one additive is selected from the group consisting of an aromatic ester, a glycol ester, a phenolic aldehyde, an aromatic aldehyde, and wood flour.

11. The fiber-containing mat of claim 1, wherein the at least one additive comprises benzyl benzoate.

12. The fiber-containing mat of claim 10, wherein the glycol ester comprises a polyethylene glycol ester.

13. The fiber-containing mat of claim 10, wherein the phenolic aldehyde comprises vanillin.

14. The fiber-containing mat of claim 10, wherein the aromatic aldehyde is selected from the group consisting of furan-2-aldehyde, benzaldehyde, 2-hydroxybenzaldehyde, 2-methoxybenzaldehyde, 3-methoxybenzaldehyde, 4-methoxybenzaldehyde, 2,4-dimethoxybenzaldehyde, 2,5-dimethoxybenzaldehyde, 3,4-dimethoxybenzaldehyde, 3,5-dimethoxybenzaldehyde, and 2,3,4-trimethoxybenzaldehyde.

15. The fiber-containing mat of claim 10, wherein the wood flour comprises oak wood flour.

16. The fiber-containing mat of claim 1, wherein the fiber containing mat further comprises a binder.

17. The fiber-containing mat of claim 16, wherein the binder includes one or more binders selected from the group consisting of an acrylic binder, a styrene acrylonitrile binder, a styrene butadiene rubber binder, a urea formaldehyde binder, an epoxy binder, a polyurethane binder, a phenolic binder, and a polyester binder.

18. The fiber-containing mat of claim 1, wherein the at least one additive comprises 0.01 wt. % to 10 wt. % of the fiber-containing mat.

19. The fiber-containing mat of claim 1, wherein the at least one additive comprises 0.01 wt. % to 5 wt. % of the fiber-containing mat.

20. The fiber-containing mat of claim 1, wherein the fiber-containing mat is a component of the lead acid battery selected from the group consisting of a separator, a positive electrode pasting mat, a negative electrode pasting mat, and a retainer/support mat.

21. A fiber-containing mat for a lead acid battery, the fiber-containing mat comprising:
a plurality of polymer fibers; and
at least one additive incorporated into at least a portion of the polymer fibers, wherein the at least one additive suppresses hydrogen evolution in the lead acid battery, and wherein the at least one additive has a standard boiling point of 160° C. or more,
wherein the fiber-containing mat is a gauntlet for holding an electrode active material for the lead-acid battery.

22. The fiber-containing mat of claim 21, wherein the at least one additive has a standard boiling point of 200° C. or more.

23. The fiber-containing mat of claim 21, wherein the at least one additive has a standard boiling point of 250° C. or more.

24. The fiber-containing mat of claim 21, wherein the plurality of polymer fibers are selected from the group consisting of polyethylene terephthalate fibers, polybutylene terephthalate fibers, polyethylene fibers, and polypropylene fibers.

25. The fiber-containing mat of claim 21, wherein the plurality of polymer fibers comprise polyethylene terephthalate fibers.

26. The fiber-containing mat of claim 21, wherein the plurality of polymer fibers are selected from the group consisting of spunbond polymer fibers, meltblown polymer fibers, and spunlace polymer fibers.

27. The fiber-containing mat of claim 21, wherein the additive is selected from the group consisting of benzyl benzoate, an aromatic ester, a glycol ester, a phenolic aldehyde, an aromatic aldehyde, and a wood flour.

28. The fiber-containing mat of claim 27, wherein:
the glycol ester comprises a polyethylene glycol ester,
the phenolic aldehyde comprises vanillin;
the aromatic aldehyde is selected from the group consisting of furan-2-aldehyde, benzaldehyde, 2-hydroxybenzaldehyde, 2-methoxybenzaldehyde, 3-methoxybenzaldehyde, 4-methoxybenzaldehyde, 2,4-dimethoxybenzaldehyde, 2,5-dimethoxybenzaldehyde, 3,4-dimethoxybenzaldehyde, 3,5-dimethoxybenzaldehyde, and 2,3,4-trimethoxybenzaldehyde; and
the wood flour comprises oak wood flour.

29. The fiber-containing mat of claim 21, wherein the electrode active material comprises lead oxide.

30. The fiber-containing mat of claim 21, wherein the fiber-containing mat is a component of the lead acid battery selected from the group consisting of a separator, a positive electrode pasting mat, a negative electrode pasting mat, and a retainer/support mat.

31. A fiber-containing mat for a lead acid battery, the mat comprising:
a plurality of polymer fibers; and
at least one additive incorporated into at least a portion of the fiber-containing mat, wherein the at least one additive suppresses hydrogen evolution in the lead acid battery, and wherein the at least one additive has a standard boiling point of 160° C. or more.

32. The fiber-containing mat of claim 31, wherein the at least one additive is incorporated into a binder that holds together the plurality of polymer fibers in the fiber-containing mat.

33. The fiber-containing mat of claim 31, wherein the at least one additive is incorporated into at least a portion of the polymer fibers.

34. The fiber-containing mat of claim 31, wherein the at least one additive is incorporated into at least a portion of the polymer fibers and a binder that holds together the plurality of polymer fibers in the fiber-containing mat.

35. A lead acid battery comprising:
a positive electrode comprising a positive active material, wherein the positive electrode further comprises a fiber-containing gauntlet for holding the positive active material;
a negative electrode comprising a lead alloy;
a separator that electrically insulates the negative electrode from the positive electrode; and
a plurality of polymer fibers incorporated into at least one of the fiber-containing gauntlet or the separator, wherein the plurality of polymer fibers include at least one additive incorporated into at least a portion of the polymer fibers, wherein the at least one additive suppresses hydrogen evolution in the lead acid battery, and wherein the at least one additive has a standard boiling point of 160° C. or more.

36. The fiber-containing mat of claim 35, wherein the at least one additive has a standard boiling point of 200° C. or more.

37. The fiber-containing mat of claim 35, wherein the at least one additive has a standard boiling point of 250° C. or more.

38. The lead acid battery of claim 35, wherein the plurality of polymer fibers are incorporated into the fiber-containing gauntlet.

39. The lead acid battery of claim 35, wherein the positive active material comprises lead oxide.

40. The lead acid battery of claim 35, wherein the plurality of polymer fibers are selected from the group consisting of polyethylene terephthalate fibers, polybutylene terephthalate fibers, polyethylene fibers, and polypropylene fibers.

41. The lead acid battery of claim 35, wherein the plurality of polymer fibers comprise polyethylene terephthalate fibers.

42. The lead acid battery of claim 35, wherein the plurality of polymer fibers are selected from the group consisting of spunbond polymer fibers, meltblown polymer fibers, and spunlace polymer fibers.

43. The lead acid battery of claim 35, wherein the additive is selected from the group consisting of benzyl benzoate, an aromatic ester, a glycol ester, a phenolic aldehyde, an aromatic aldehyde, and a wood flour.

44. The lead acid battery of claim 43, wherein:
the glycol ester comprises a polyethylene glycol ester,
the phenolic aldehyde comprises vanillin;
the aromatic aldehyde is selected from the group consisting of furan-2-aldehyde, benzaldehyde, 2-hydroxybenzaldehyde, 2-methoxybenzaldehyde, 3-methoxybenzaldehyde, 4-methoxybenzaldehyde, 2,4-dimethoxybenzaldehyde, 2,5-dimethoxybenzaldehyde, 3,4-dimethoxybenzaldehyde, 3,5-dimethoxybenzaldehyde, and 2,3,4-trimethoxybenzaldehyde; and
the wood flour comprises oak wood flour.

45. The lead acid battery of claim 35, wherein the lead acid battery comprises an aqueous liquid electrolyte comprising sulfuric acid.

46. The lead acid battery of claim 35, wherein the lead acid battery is an absorbent-glass-mat lead acid battery, and wherein the separator includes the plurality of polymer fibers, and further wherein the separator absorbs an electrolyte comprising sulfuric acid.
